(19) United States
(12) Patent Application Publication
(10) Pub. No.: US 2024/0397299 A1
(43) Pub. Date: Nov. 28, 2024

(54) SPATIALLY ROUTING AND TRACKING ONE OR MORE RESOURCES IN RESPONSE TO AN EMERGENCY EVENT

(71) Applicant: CWTCH, Inc., Seattle, WA (US)

(72) Inventors: Melinda R. YORMICK, Seattle, WA (US); Aaron COOKE, Seattle, WA (US)

(73) Assignee: CWTCH, Inc., Seattle, WA (US)

(21) Appl. No.: 18/674,648

(22) Filed: May 24, 2024

Related U.S. Application Data
(60) Provisional application No. 63/469,370, filed on May 27, 2023.

(51) Int. Cl. H04W 4/90; H04W 4/029; H04W 4/12

(52) U.S. Cl. CPC H04W 4/90; H04W 4/029; H04W 4/12

(57) ABSTRACT

System and methods for ensuring that one or more resources are routed to an emergency event location in a timely manner. The methods may be implemented by a computing system and may include selecting one or more responders including equipment to address an emergency event. Transmit one or more alerts to the client computing devices of the one or more selected responders directing the one or more selected responders to the emergency event location. Verifying that the one or more selected responders and the equipment are enroute to the emergency event location. And tracking the movements of the one or more selected responders.

### CROSS-REFERENCE TO RELATED APPLICATION [S]

This application claims priority to U.S. Provisional Patent Application Ser. No. 63/469,370, filed on May 27, 2023, which is incorporated herein by reference in its entirety.

### FIELD

The present disclosure relates to emergencies, and more particularly, to spatially routing one or more resources to an emergency event location.

### BACKGROUND

Due to their nature, medical facilities such as hospital buildings, clinics, and medical campuses must deal with a variety of emergency events, such as medical emergencies, armed intruders, fire, infant abduction, hazardous spills, and so forth. The conventional way of handling these emergency events has remained unchanged for decades. That is, traditionally each type of emergency is given a color code (e.g., an emergency code), such as blue code (e.g., heart or respiration stops), red code (e.g., fire), pink code (e.g., infant abduction), and so forth.

On any given day, at least one code team of responders will be assigned to respond to an emergency code. Each code team may be comprised of team members with different skills and expertise. For example, for a medical emergency, the corresponding code team may consist of doctors, nurses, therapists, certified nursing assistant (CNA), etc. For fire emergencies or active shooter incidences, the corresponding code team may consist of firefighters and/or law enforcement members.

The conventional approach for activating and sending the appropriate code team to the location of an emergency event is to announce a code message over the public address (PA) system of the medical facility including the location of the emergency event, for example, “code blue, third floor, corridor four, room 208.”

This approach to dealing with emergency events has proven deficient in a number of ways and circumstances. For example, the layout of modern medical facilities, which are often very large, tend to be very complex, with many similar-looking corridors and wings. Even medical personnel who have worked at the same medical facility for many years may get lost on the way to, for example an emergency event since there are often many parts of the facility that the personnel may never have had an opportunity to visit. Further, turnover of staff at some medical facilities can be very high. Thus, the use of temporary staffing, such as traveling nurses, is common in many medical facilities. As a result, it is not that uncommon for responders (e.g., code team members) to get lost on their way to emergency events.

In many emergency events, such as medical emergencies, certain equipment are needed to address the corresponding medical emergency. Examples of equipment that may be needed in a medical emergency include, for example, a defibrillator, patient monitoring devices, syringes, and medicine, while in the case of a fire emergency, fire extinguishers and other firefighting equipment. Many medical facilities have specialized kits/carts containing specialized equipment/medicine placed throughout their facilities to handle the various types of emergencies. Whenever there is an emergency event, at least one of these specialized kits/carts must be brought to the emergency event location by one of the responders responding to the code message. However, locating the appropriate kit/cart may prove to be cumbersome and time-consuming, particularly when the responder assigned to bring the specialized kit/cart is in an area of the medical facility that he or she is not familiar with, or the medical emergency is in an unfamiliar area of the medical facility.

It is also not that uncommon that when a code message is broadcasted over the PA system, certain team members (e.g., responders) of the code team assigned to respond to the corresponding emergency may not be able to respond to the emergency event for a variety of reasons. For example, some members of the code team may already be on an emergency call, may be in the middle of a medical procedure, in a location where she or he may not receive the coded message, and so forth.

It is also essential to be able to track the locations and movements of responders, as well as needed equipment, while they are enroute to the emergency event to ensure that they will, in fact, arrive at the emergency event location in a timely manner.

### BRIEF DESCRIPTION OF THE DRAWINGS

FIG. 1A is a high-level block diagram of an example network environment according to some embodiments.

FIG. 1B is a block diagram of the of the resource tracking and control platform illustrated in FIG. 1A according to some embodiments.

FIG. 2 is a high-level block diagram of an example computing device according to some embodiments.

FIG. 3 is ensuring that a responder or responders and needed equipment reach an emergency event location in a timely manner according to some embodiments.

FIGS. 4A and 4B illustrate an example process for ensuring that one or more responders and needed equipment reach an emergency event location in a timely manner according to some embodiments.

FIGS. 5A and 5B illustrate an example process for ensuring that one or more responders and needed equipment reach an emergency event location in a timely manner according to some embodiments.

FIG. 6 is a high-level process for tracking locations and/or movements of one or more tagged resources, and to execute one or more actions in response to the movements and/or locations of the one or more tagged resources according to some embodiments.

### DETAILED DESCRIPTION

According to various embodiments of the present disclosure, emergency response coordination systems and methods are disclosed herein to ensure that resources, such as emergency responders and emergency equipment are routed to an emergency event location in a timely manner. That is, the emergency response coordination (ERC) systems and methods may select one or more responders and needed equipment for addressing an emergency event, to direct and guide selective responders and equipment to an emergency event, and to track the selected responders and equipment at least until they reach the emergency event location, wherein the responders and equipment are selected, based at least in part, on their locations relative to the emergency event location. The systems and methods, if needed, may also find one or more alternative responders/equipment when any of the selected responders and/or needed equipment are detected as not being enroute to the emergency event location. In various embodiments, a responder may be any person who can respond to or is qualified to respond to an emergency event including, for example, healthcare workers (e.g., physicians, nurses, therapists, certified nursing assistants (CNAs), orderlies, emergency medical technicians, emergency medical technicians (EMTs), etc.), law enforcement officers, security guards, firefighters, or any other individual who can play a role or assist in responding to an emergency event.

The ERC systems and methods may also route at least one of the selected responders to secure emergency equipment (e.g., medical devices and medicine) while enroute to the emergency event location. Alternatively, if the emergency equipment is robotic equipment, such as a robotic cart carrying emergency devices and supplies (e.g., medicine), then the robotic equipment may be directed to the emergency event location, Note that although the following description of the ERC systems and methods will describe the ERC systems and methods in the context of emergencies connected with medical facilities and medical emergencies, in various embodiments, the ERC systems and methods may be implemented in various other environments, such as police or fire emergencies occurring in, for example, a school building or campus, an airport, an office building, and so forth.

In various embodiments, to facilitate the various functionalities and features of the ERC systems and methods, one or more positioning systems that are capable of tracking precise locations of various resources (e.g., medical equipment, humans including patients, emergency responders and healthcare providers, medicine, firefighting equipment, and forth) in, for example, indoor environments may be employed. For example, in various embodiments, to track the precise locations of resources indoors, the ERC systems and methods may employ one or more positioning systems such as one or more of ultra-wide band (UWB) system, a local positioning system (LPS), a radio frequency identification (RFID) system, an Xtreme low-energy (XLE®) system, geofencing technology, and so forth, which are superior to conventional GPS systems that do not perform well indoors. To track resources, many of these positioning systems require the resources to be tagged with “location tags” such as RFID tags, UWB tags, and so forth.

According to various embodiments of the present disclosure, resource tracking and response systems and methods are disclosed herein to track locations and movements of one or more mobile or movable facility resources (hereinafter simply “resources”). Based, at least in part, on the movements and/or locations of the one or more resources, the resource tracking and response systems and methods may execute one or more actions.

Modern facilities, such as medical facilities including hospitals, must be able to accurately track and record the movements and locations of its resources. Failure to do so can impact, for example, patient treatment outcomes. For example, during the intake process of an emergency room (ER) patient, such as an automobile accident victim, the patient may be taken to multiple facility locations for medical treatment, examination, testing, holding, and so forth. Keeping track and accurately recording the exact locations and movements of the patient and the treatments and testing that they may or may not have received, as well as when these events occurred, may impact treatment outcomes. For purposes of the following, references to a “resource” or “resources” may be in reference to persons (e.g., patients, healthcare providers including doctors, nurses, therapists, law enforcement officers, firefighters, EMTs, and so forth), equipment (e.g., medical devices, and/or any other moveable or mobile facility “items.”

The resource tracking and response systems and methods to be described herein may precisely track the locations and movements of a resource, such as a patient, and analyzing the movements or locations of the resource, as well as the timing of these occurrences, may take one or more actions. In some embodiments, the one or more actions to be taken may be based on the movements or lack of movements of a resource, the timing of those movements, the movements of the resource relative to the movement or locations of other resources, the timing of these events, and so forth. Among the actions that can be taken include, for example, the transmission of an alert to indicate the current status of the resource to interested parties, generating alerts, locking secure security doors, integrate data with secure documentation, initiate a security response, identify utilization/need discrepancies, and so forth. For example, if the patient (e.g., accident victim) has finished being x-rayed and is now being moved back to the emergency room, the resource tracking and response systems and methods may transmit an alert to a client computing device of emergency room personnel (e.g., supervising ER nurse) that the patent is returning to the emergency room. Further, as the patient is moved from one location to another during the intake process, the movements, in some cases, may be recorded and linked to a specific event or resource. To facilitate tracking of resources, the resources may be tagged with location tags of a positioning system as briefly described above.

According to various embodiments of the present disclosure, robotics controller systems and methods are disclosed herein for, among other things, controlling and tracking robotic devices/equipment. In some embodiments, the robotics controller systems and methods may be used to support the ERC systems and methods and the resource tracking and response systems and methods as will be further described herein. In various embodiments, the robotic devices to be controlled and tracked by the robotic controller systems and methods include, for example, robotic carts that carry, among other things, medical devices and medicine. In some embodiments, the robotic devices may include one or more types of sensors, including cameras (e.g., digital single-lens reflex cameras, infrared cameras, and so forth), microphones, radars, and so forth.

In various embodiments, and as will be described in greater detail herein, the emergency response coordination (ERC) systems and methods for ensuring that emergency responders and emergency equipment are timely routed to an emergency event location may be implemented using a single network computing device, such as a server, a desk or laptop computer, a workstation, and so forth, or may be implemented by a plurality of network computing devices (e.g., a cloud implementation).

In some embodiments, an ERC method may begin when an ERC system receives an emergency notification indicating the occurrence of an emergency event (e.g., a medical emergency). The emergency notification, in some cases, may have been transmitted by a computing device located at the emergency event location and may include certain information such as emergency type and a location indicator that indicates the location of the emergency event. For example, the emergency notification may include the coordinates or address of the emergency event location, or if a computing device located at the emergency event location is a stationary device (e.g., a patient monitoring device) assigned to a particular location then the emergency notification may simply include an identifier for the computing device, which can be used to determine the location of the emergency event.

In some cases, the emergency notification that may be received by the ERC system may identify the type of emergency by simply indicating the appropriate emergency code (e.g., code blue, code pink, etc.). Alternatively, the emergency notification may include a colloquial textual or audio description (e.g., “fire” or “no pulse”) of the emergency provided by an emergency caller. In some implementations, the computing device that transmits the emergency notification may be, for example, a mobile computing device, such as a smartphone or a tablet computer held by the emergency caller. Alternatively, such a computing device may be a dedicated computing device for communicating with the ERC system.

In some embodiments, the ERC method may include an operation for identifying the appropriate response team (e.g., code team) and equipment needed to address the emergency event based, at least in part, on the emergency type (e.g., code blue, code red code, and so forth) of the emergency event. Since there may be many identical equipment (e.g., emergency medical carts) placed at multiple locations of, for example, a medical facility, the selection of the equipment may be based on the location of the selected equipment with respect to the emergency event location and/or one or more team members of the identified response team. Upon identifying the appropriate response team, alerts may be sent/transmitted to the client computing devices of team members (e.g., responders) of the appropriate response team.

In various embodiments, a client computing device may be a mobile computing device, such as a smartphone or a tablet computer that can be carried or worn by a user. In various embodiments, a client computing device may be endowed with a system (e.g., an application) that may allow it to be precisely located.

A verification operation may then be executed to determine whether the team members of the response team (as well as any needed equipment) are enroute to the location of the emergency event. The verification may be a two-step verification that includes verifying that the team members, through their client computing devices, confirmed that they are enroute to the emergency event; and that the team members (e.g., the client computing devices of the team members) and the needed equipment are spatially detected moving towards or enroute to the location of the emergency event within a predefined amount of time following reception of the confirmations from the team members that they are enroute to the emergency event. In some embodiments, the equipment may be tagged with a location tag or a device that facilitates tracking of the location/movements of the equipment such as a UWB tag, an RFID tag, LPS tag, and so forth. Alternatively, an equipment may be tagged when it incorporates a device or features that allow it to be spatially tracked.

In some embodiments, if the two-step verification cannot be completed for any of the team members (e.g., a team member does not confirm through their client computing device that they are enroute or the client computing device of the team member is not detected moving towards or enroute to the emergency event) then a reminder may be transmitted to the client computing device of the team member who cannot be verified as being enroute to the emergency location requesting the team member to confirm that the team member is enroute to the emergency event location.

Alternatively or in addition, if any of the team members cannot be verified that they are enroute to the emergency event, then an alternate responder may be selected to respond to the emergency event. That is, in some cases, if a team member cannot be verified that he or she is enroute to the emergency event location, then a reminder may first be sent to the client computing device of the team member to give the team member another opportunity to respond to the alert and move towards the emergency event location. If, however, the team member fails to respond to the second alert and/or is not detected as moving towards the emergency then a message may be sent to the team member calling him or her off from the emergency response and an alternate responder may be selected and alerted. Alternatively, rather than sending a second alert or reminder to the team member who has not responded to the alert or is not detected as moving towards the emergency event location, an alternate responder may be immediately selected and alerted.

The selection of alternate responders may be based on a number of factors including their qualifications (e.g., skills, certifications, title, practice areas, and so forth), whether the alternate responders are active (e.g., have checked in and are on duty), their current location relative to the emergency event location (e.g., preference for responders who are closer in terms of travel distance or who's estimated time of arrival to reach the emergency location is the lowest), their proximity to the equipment needed for the emergency event (e.g., selecting a first responder rather than a second responder because the first responder is closer to the equipment needed for the emergency when the equipment, for example, is not a robotic cart), and so forth, as will be described in greater detail herein. Note that in various embodiments, responders who may be selected for responding to the emergency event may be ranked based, for example, on the above-mentioned factors (e.g., their location relative to the emergency event location and/or the location of the needed equipment).

After selecting responders for responding to the emergency event (regardless of whether the responders are members of the original response team assigned to respond to the emergency event or are alternate or substitute responders), alerts may be electronically transmitted to the client computing devices of the selected responders directing (or requesting) the selected responders to the emergency event location. In various embodiments, the alert that each selected responder receives via their client computing device may include the specific route that the selected responder may use to reach the emergency event location from the responder's current location. Alternatively, if the client computing device of the selected responder includes a navigation application/system capable of providing routes to an emergency event location in accordance with the ERC methods and systems described herein (e.g., able to navigate through a multi-storied building), then the alert sent to the client computing device of a selected responder may simply include the coordinates or address of the emergency event location.

In various embodiments, the alerts may be transmitted to the client computing devices of the selected responders wirelessly and/or via wired connections. In some cases, the alerts may include additional information such as emergency type of the emergency event and if the responder is designated to secure needed equipment, an equipment identifier (e.g., name of the equipment or emergency cart or kit) may be provided to the designated responder. For selected responders designated to secure and bring the needed equipment to the emergency event location, they will be routed to the emergency event location via the location of the needed equipment. That is, when the needed equipment is not a robotic equipment, the ERC system may route the selected responders designed to secure and bring the needed equipment to the location of the equipment first before routing the selected responders to the emergency event location. In some embodiments, the responder selected to secure and bring the needed equipment to the emergency event location may be one of the persons responsible for bringing such equipment to an emergency event. For example, in a medical emergency, the person designated to bringing the medical equipment may not even be a medically trained person, but instead, may be a hospital worker who has been assigned to perform such tasks (e.g., bringing medical equipment to needed locations such as to emergency event locations).

In some embodiments, an alert that may be transmitted to the client computing device of a selected responder may comprise of two or more separate messages that may be sent independently. For example, transmitting to the client computing device of the selected responder a first alert message that alerts the occurrence of an emergency event and requests the selected responder to confirm that he or she will be responding to the emergency event, and a second alert message that is sent after the selected responder confirms that he or she will be responding to the emergency event and that includes the route to the emergency event from the current location of the selected responder.

As noted above, once members of an appropriate response team (e.g., code blue team) have been alerted or notified of an emergency event, a two-step verification operation for each member of the response team may be performed to verify or confirm that each team member (e.g., responder) is enroute to the emergency event location. Similarly, once the alerts have been transmitted to the client computing devices of the selected responders, a two-step verification operation for each selected responder may be performed to verify or confirm that each selected responder is enroute to the emergency event location. That is, verify that each of the selected responders has responded through their client computing device that they will be enroute or beginning their trek to the emergency event and verify that the client computing device of each selected responder is spatially moving towards (e.g., began their trek to) the emergency event location within a predefined period (e.g., 20 seconds or less) of time from when the client computing devices of the selected responders received the alerts.

In some embodiments, the two-step verification operation may further include an operation to verify that the equipment needed for the emergency event is detected as spatially moving toward the emergency event location. For example, if the responder designated to bring the equipment to the emergency event location passes the equipment location without securing and bringing the equipment toward the emergency event location, then a reminder may be sent to the client computing device of the designated responder requesting the designated responder to go back to the equipment location to bring the equipment to the emergency event location. Alternatively, rather than sending a reminder to the client computing device of the designated responder, one of the other selected responders who is detected to be in the vicinity of the equipment may be rerouted to the equipment location and requested to bring the equipment to the emergency event location.

In some embodiments, the rerouting of a responder to the equipment location may be implemented by sending a new alert to the responder with a new route to the emergency event location via the equipment location. In embodiments where the equipment is robotic equipment, if the robotic equipment is detected as not moving towards the emergency event location, then another robotic equipment may be directed to the emergency event location. Alternatively, a responder may be directed to secure and bring an alternate equipment, which may not be robotic, to the emergency equipment location.

In various embodiments, if one or more of the selected responders cannot be verified as being enroute to the emergency event location, then alerts/reminders may be sent to the client computing devices of the one or more selected responders reminding or directing the one or more selected responders to the emergency event. Alternatively, alerts may be sent to the client computing devices of one or more alternate or substitute responders directing them to the emergency event. As before, the alerts sent to the client computing devices of the one or more alternate responders may include the routes to the emergency event location from the locations of the client computing devices of the one or more alternate responders. Alternatively, the routes may be provided after the alternate responders have confirmed that they will be enroute to the emergency event location.

In various embodiments to determine or verify that the client computing devices of the selected responders are spatially moving toward the emergency event location, one or more positioning systems may be employed that are capable of, for example, precisely tracking locations of tagged resources (e.g., humans carrying mobile devices, equipment tagged with location tags for detecting their location, medicine tagged with location tags, and so forth) in, for example, an indoor facility (e.g., multi-storied hospital). For example, in some embodiments, one or more of local positioning system (LPS), ultra-wide band (UWB) positioning system, radio frequency identification (RFID) system, BLUETOOTH Low Energy (LE) system, and Xtreme Low Energy (XE®) system may be employed.

In various embodiments, in response to verifying that the responders selected to respond to an emergency event are at least enroute (e.g., on their way or have begun their “trek”) to the emergency event location, the movements of the client devices of the selected responders are tracked at least until the client computing devices are detected arriving at the emergency event location. In some embodiments, the tracking of the selected responders may include tracking the movements of the needed equipment. For these embodiments, the tracking of the selected responders may include transmitting the movement information of at least one or more of the selected responders and/or the needed equipment to a computing device located at the emergency event location, which may have been the device that sent the original emergency notification. By doing so, the personnel at the emergency event location can be updated on the statuses of the one or more selected responders and/or the needed equipment. In some cases, the movement information of the needed equipment may additionally or alternatively be transmitted to at least one of the client computer devices of the selected responders. That is, by doing so, the responders themselves are appraised or assured that the needed equipment will be available at the emergency event location.

In some embodiments, if a client computing device of a selected responder is detected as not moving towards or stopped moving towards the emergency event location, then a reminder may be sent to the client computing device of the selected responder to respond to the emergency event and/or an alert may be transmitted to a client computing device of an alternative responder directing the alternate responder to the emergency event.

In various embodiments, the above-described ERC method may be performed by an ERC system that is implemented by one or more network devices such as one or more servers. Alternatively, at least some operations of the above-described ERC method may be implemented by a client computing device (e.g., a mobile device executing a client application) of a responder. For example, in some implementations, a mobile device of a responder may have a client application installed on the mobile device that allows it to generate a route to an emergency event location once coordinates or an address (e.g., location identifier) of the emergency event location is received from the emergency response coordination system rather than receiving the route from the emergency response coordination system. This approach may be particularly useful when the network connections are unreliable.

Additional details regarding the above-described emergency response coordination systems and methods will be provided below with reference to the accompanying figures.

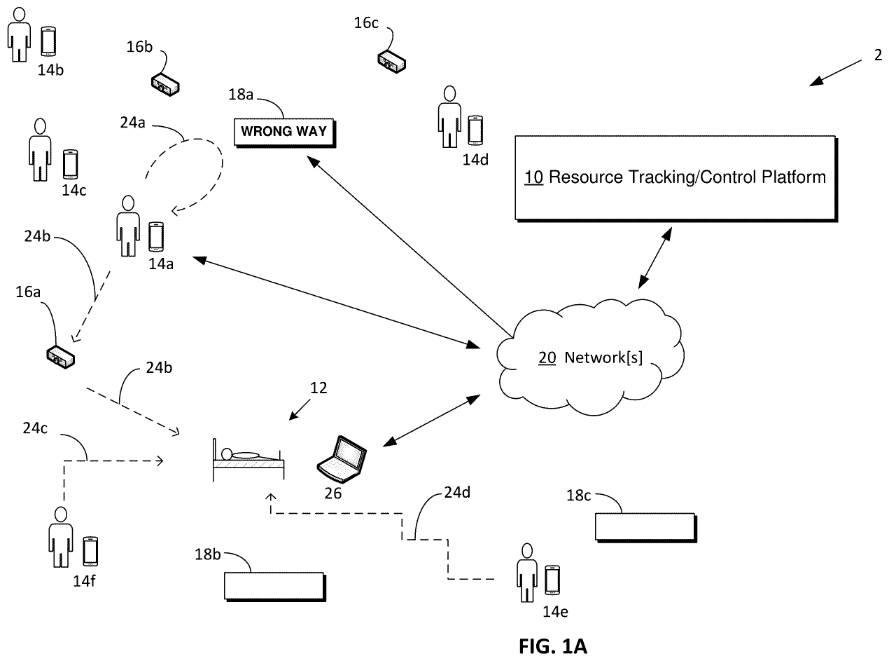

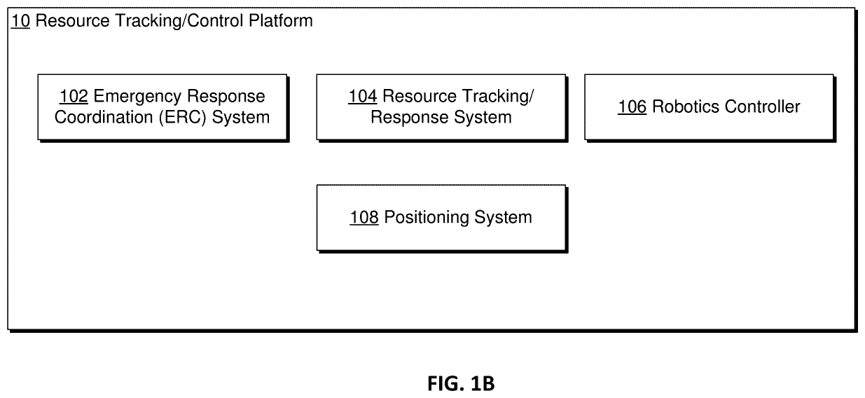

FIG. 1A is a high-level block diagram of an example network environment according to some embodiments. More specifically, the above-described emergency response coordination (ERC) systems and methods may be implemented in the example environment 2 of FIG. 1A. As illustrated, the network environment 2 includes a resource tracking and control platform 10 that may communicate with a plurality of client computing devices 14a, 14b, 14c, 14d, 14c, and 14f of a plurality of responders, a plurality of equipment 16a, 16b, and 16c, a plurality of electronic signages 18a, 18b, and 18c, and a local computing device 26 via one or more networks 20. The one or more networks 20 may include one or more wireless and/or wired networks, which may include one or more of, for example, a cellular and/or data network, a wireless local area network (WLAN), a local area network (LAN), a personal area network (PAN), and so forth.

In the following, “*” represents a wildcard. Thus, references in the following description to, for example, “a client computing device 14*” may be in reference to client computing device 14a, client computing device 14b, client computing device 14c, client computing device 14d, client computing device 14fe, or client computing device 14f of FIG. 1A. For case of explanation and illustration, only six client computing devices 14*, three equipment 16*, three electronic signages 18*, and a single local computing device 26 are illustrated. However, and as will be recognized by those of ordinary skill in the art, such a network environment 2 may include more or fewer than six client computing devices 14*, three equipment 16*, three electronic signages 18*, and a single local computing device 26 in various alternative embodiments.

In various embodiments, the response tracking and control platform 10 may be implemented by a single network device (e.g., a server or a workstation) executing computer-readable programming instructions. Alternatively, the content aggregator system 10 may be a cloud-based system implemented by a plurality of network computing devices such as one or more servers, workstations, and so forth, that may execute computer-readable programming instructions. Alternatively, the response tracking and control platform 10 may be implemented using one or more dedicated network devices (e.g., dedicated servers), such as those that employ application-specific integrated circuit (ASIC), or a combination of dedicated servers and programmable devices.

The response tracking and control platform 10 may be configured to, among other things, coordinate, track, and communicate with various resources of a facility, such as a hospital, a medical campus, a school facility including a school building or campus, a business facility including an office building, an airport, and so forth. As noted above, references to a “resource” or “resources” may be in reference to humans (e.g., patients, physicians, nurses, therapists, CNAs, EMTs, security or police officers, firefighters, and so forth, who in some cases, may be emergency responders), equipment (e.g., emergency medical carts, medical devices, medicine, robotic medical carts, and so forth), and/or any other facility resources that may be mobile. Note that although the following description of the emergency response coordination (ERC) systems and methods will be described in the context of being implemented in a medical facility, the ERC systems and methods may also be employed in other environments such as in a commercial office building, a school building or campus, an airport, and so forth in response to various types of emergency events (e.g., medial emergencies, fire emergencies, police emergencies, hazardous material emergencies, and so forth).

Referring to FIG. 1B, which is a block diagram of the resource tracking and control platform 10 in accordance with various embodiments. As illustrated, the resource tracking and control platform 10 may include sub-modules including an emergency response coordination (ERC) system 102, a resource tracking and response system 104, a robotics controller 106, and a positioning system 108. In various embodiments, the ERC system 102 may be configured to implement an ERC method for ensuring that responders and needed emergency equipment are routed to an emergency event location in a timely manner as described above and as will be further described in greater detail herein. In contrast, the resource tracking and response system 104 may be a module that is configured to, among other things, track the movements of one or more resources of a facility and based on the movements of the one or more resources, execute one or more actions. The robotics controller 106, in brief, is a module that is configured to direct and track one or more robotic equipment such as robotic medical carts carrying medical devices and/or medicine, or other types of robotic devices to perform various tasks. The positioning system 108 is a module that may interface with components of one or more positioning systems (e.g., UWB system, LPS system, and so forth) to, among other things, collect locational and movement data of one or more resources. In various embodiments, the positioning system 108 may support the ERC system 102, the resource tracking and response system 104, and the robotics controller 10 by providing positioning and movement data of resources to the ECR system 102, the resource tracking and response system 104, and the robotics controller 106. Similarly, when each of the other modules (the ERC system 102, the resource tracking and response system 104, and the robotics controller 106) perform their respective operations, they may interact with the other two modules. For example, when the ERC system 102 is executing the emergency response coordination (ERC) methods described above, the ERC system 102 may interact with the robotics controller 106 to direct, for example, a robotic medical cart to an emergency event location, and/or interact with the resource tracking and response system 104 to provide to the resource tracking and response system 104 activity information of resources in response to an emergency event.

Referring back to FIG. 1A, in various embodiments, at least a subset of the client computing devices 14*, the equipment 16*, the electronic signages 18*, and the single local computing device 26 may be located within an indoor facility such as a hospital. Note that although the following description of the emergency response coordination systems and methods will be described in the context of a medical facility and medical emergencies, in various embodiments, the systems and methods to be described herein may be implemented in the context of other environments such as a school building or campus, an airport, an office building, and so forth, to deal with both medical and other types of emergencies.

To facilitate understanding of the ERC systems and methods described herein, the following example scenario is provided that describes how the ERC system 102 may respond to an example emergency event according to some embodiments. When an emergency event (e.g., a medical emergency, an infant abduction, a fire, a toxic spill, and so forth) occurs at an emergency event location 12, a “local” computing device 26 may transmit an emergency notification to the ERC system 102 via one or more networks 20. The local computing device 26 (herein simply “computing device 26”) may be, for example, a computing device for monitoring a patient's physiological characteristics or a client computing device of a healthcare provider. The emergency notification may indicate the emergency event or the type of emergency that is associated with the emergency notification. For example, if a healthcare provider such as a nurse is reporting the emergency event via a client computing device, the emergency notification may include a textual or audio message that texturally or audibly describes the emergency (e.g., “no pulse”). Alternatively, the emergency notification may provide a specific emergency code, such as “code blue.” The emergency notification may also include the location of the emergency event in the form of an address, coordinates, a location identifier (e.g., a location code), or other ways of identifying the emergency event location 12.

Upon receiving the emergency notification, the ERC system 102 may determine the type of emergency (e.g., code red, code blue, code yellow, and so forth) associated with the emergency event and the location of the emergency event based, at least in part, on the information contained in the emergency notification. Of course, if the emergency notification already indicates the emergency type, then such a determination may entail simply processing/reading the emergency notification. Alternatively, if the emergency notification includes a colloquial textual and/or audio description of the emergency event provided by an emergency caller, then the ERC system 102 may ascertain the emergency type by analyzing the textual or audio description to determine whether the description includes certain key terms such as “cardiac arrest,” “fire,” “abducted,” and so forth.

Upon determining the type of emergency and the location of the emergency event, the ERC system 102 may select one or more responders from a plurality of responders that may be available to address the emergency response based on a number of factors. For example, in cases where there are response teams assigned to handle different emergency types, the selection process may initially entail determining team members of the response team designated to handle the emergency type of the emergency event. Alerts may then be transmitted to each team member of the designated response team directing them to the emergency event location. A determination may then be made as to whether all, some, or none of the team members of the designated response team will be responding to the emergency event.

In some cases, if team members of the designated response team is not available because they are already attending another emergency, then the ERC system 102 will execute a selection process, to be described below, to select alternate responders for responding to the emergency event. If, on the other hand, at least some or all of the team members of the response team are available to attend the emergency event, then an alert may be sent to the client computing device (e.g., a mobile device loaded with a client application) of each of the available team members.

After transmitting the alerts to the client computing device of each available team member, a two-step verification operation may be performed (e.g., a first step to verify that the team member has confirmed that he or she will be enroute to the emergency event location and a second step to verify that the client computing device of the team member is moving towards the emergency event location within a predefined period such as 20 seconds from when the alert was generated) to verify that each of the available team members is enroute to the emergency event location. If one or more of the team members of the designated response team is not able to respond to the emergency event, then a selection operation may be performed by the ERC system 102 to select one or more alternate responders (or simply “responders”) to respond to the emergency. The selection of the one or more responders for responding to the emergency event may be based on a number of factors including, for example, their relative distance or estimated time of arrival (ETA) to the emergency event location 12 and/or their relative distance or ETA to an equipment 16* that is needed to address the emergency event. That is, in some cases, one or more of the selected responders may be routed to the needed equipment before being routed to the emergency event location 12 so that they can bring the needed equipment 16* to the emergency event location 12. Other factors that may be considered in selecting responders for responding to an emergency event include, for example, the qualifications of the responders such as field of expertise (e.g., medical specialty), certifications, experience, and so forth.

In the example scenario depicted in FIG. 1A, three responders (e.g., the responders associated with client computing devices 14a, 14e, and 14f) have been selected to respond to an emergency event at emergency event location 12. In contrast, the responders associated with client computing devices 14b, 14c, and 14d were not selected to respond to the emergency event but may be selected as one or more alternate responders if one or more of the selected responders (e.g., responders associated with client computing devices 14a, 14c, and 14f) are unavailable. Illustrated also in FIG. 1A are three identical or similar equipment 16a, 16b, and 16c located at three different locations. Note that in this scenario, the emergency event location 12 and each of the client computing devices 14a, 14c, and 14f (and their associated selected responders) are located in a multi-storied indoor facility.

After selecting the three responders, the ERC system 102 of the resource tracking and control platform 10 transmits to the client computing devices 14a, 14c, and 14f alerts requesting or directing the three selected responders associated with the client computing devices 14a, 14c, and 14f to go to the emergency event location 12. As part of transmitting alerts to the client computing devices 14a, 14c, and 14f, each of the client computing devices 14a, 14c, and 14f may be provided with a route to the emergency event location 12 from the current locations of the client computing devices 14a, 14e, and 14f. Since the client computing devices 14a, 14c, and 14f may be located in different locations, they may each be provided with different routes with different starting points.

According to various embodiments, there are alternative ways of providing routes to each of the client computing devices 14a, 14c, and 14f. For example, in some embodiments, the routes may be provided to the client computing devices 14a, 14c, and 14f when the ERC system 102 transmits the complete electronic routes to the client computing devices 14a, 14c, and 14f. Alternatively, if the client application of each of the client computing devices 14a, 14c, and 14f are endowed with a navigation system capable of generating routes that navigate through, for example, a multi-storied facility then the ERC system 102 may only need to transmit to the client computing devices 14a, 14c, and 14f the coordinates or a location identifier (e.g., address or location code) of the emergency event location 12. Based on the information (e.g., emergency event location coordinates) that is provided by the ERC system 102, the navigation system of each client computing devices 14a, 14c, and 14f may determine the respective route to the emergency event location 12.

In FIG. 1A, the selected responder associated with client computing device 14a, has been selected/designated to bring equipment 16a to the emergency event location. Accordingly, the route provided to the client computing device 14a is a route that directs the selected responder associated with the client computing device 14a to the location of the equipment 16a first before being routed to the emergency event location 12. In the example scenario illustrated in FIG. 1A, the selected responder associated with the client computing device 14a initially goes the wrong way along path 24a. The ERC system 102 upon detecting (e.g., detecting through the positioning system 108 based on data provided by, for example, a UWB system, a LPS system, or other navigation system) the client computing device 14a moving in the wrong direction, causes an electronic signage 18a that is near the selected responder associated with the client computing device 14a to display and/or audibly provide a message that alerts the selected responder that he or she is moving in the wrong direction. That is, in some embodiments, the electronic signage 18a may broadcast an audio message or alarm to alert the selected responder associated with the client computing device 14a that he or she is moving in the wrong direction. Additionally or alternatively, the ERC system 102 may send a message to the client computing device 14a of the selected responder that he or she is going the wrong way. That is, in some cases the client computing device may generate an audio alarm to alert the selected responder that he or she is going the wrong way.

The selection of the electronic signage 18a from a plurality of electronic signages 18* to visually and/or audibly indicate that the selected responder is moving in the wrong direction may be based on the direction that the client computing device 14a is moving (e.g., selecting an electronic signage 18* that the client computing device 14a is predicted to pass in its current heading). For example, if the client computing device 14a is detected as moving down a long hallway, the ERC system 102 may activate the electronic signage 18a that is located along the predicted path (e.g., down the hallway) of the client computing device 14a just ahead of the selected responder client computing device 14a. In some embodiments, if the selected responder is wearing, for example, an augmented reality (AR) device, the selected response may be rerouted back in the correct direction.

In the scenario illustrated in FIG. 1A, upon seeing the signage 18a, the selected responder associated with the client computing device 14a turns around (e.g., makes a U-turn) and heads back towards the location of the equipment 16a along path 24b following the route provided by the ERC system 102. Again, note that the ERC system 102 may provide a route by electronically providing the full electronic route to the client computing device 14a, or alternatively, provide the coordinates or location code of the emergency event location 12 so that the client computing device 14a can ascertain the correct route to the emergency event location 12.

FIG. 1A shows the paths 24c and 24d taken by the selected responders associated with client computing devices 14f and 14e to reach the emergency event location 12, which in this case, are the routes provided to the client computing devices 14f and 14c. Once each of the selected responders associated with the client computing devices 14a, 14c, and 14f has confirmed that they will or are enroute to the emergency event location 12, the ERC system 102 will closely track the movements of the client computing devices 14a, 14c, and 14f. In some embodiments, upon detecting any of the client computing devices 14a, 14e, and 14f has stopped moving toward the emergency event location 12 or detecting that any of the client computing devices 14a, 14c, and 14f are deviating from their assigned route to the emergency event location 12, the ERC system 102 may send a reminder to the client computing device 14a, 14c, or 14f of the wayward responder to continue their movement to the emergency event location 12.

If the ERC system 102 does not receive a confirmation from the wayward responder confirming that he or she is enroute to the emergency event location 12 and/or does not detect the client computing device 14a, 14c, or 14f of the wayward responder moving towards the emergency event location 12 within a predefined period of time (e.g., 20 seconds) from the time that the reminder was sent to the client computing device 14a, 14e, or 14f of the wayward responder, then an alert may be sent to the client computing device of an alternate responder requesting or directing the alternate responder to the emergency event location 12 in place of the wayward responder. For example, in the example scenario of FIG. 1A, if the client computing device 14f of a selected responder is detected as deviating from the assigned route, then the ERC system 102 may initially send a reminder to the client computing device 14f.

If the selected responder does not respond to confirm that he or she will be enroute, or if the client computing device 14f of the selected responder is not detected moving towards the emergency event location 12 within a predefined period of time (e.g., 20 seconds) from when the reminder was sent by the ERC system 102, then the ERC system 102 may transmit to the client computing device of an alternate responder, such as client computing device 14d, an alert directing or requesting the alternate responder to go to the emergency event location 12. After sending the alert to the client computing device 14d of the alternate responder, in various embodiments, the ERC system 102 may implement the two-step verification as described above to verify that the alternate responder is, in fact, enroute to the emergency event location 12, and track the movements of the client computing device 14d to confirm that the alternate responder reaches the emergency event location 12.

In various embodiments, the resource tracking and response system 104 of the resource tracking and control platform 10 may monitor the activities at the emergency event location 12. For example, the resource tracking and response system 104 may track and record which resources (e.g., patient, responders, equipment, medicine, and so forth) are at the emergency event location 12 including length of time at the emergency event location 12. For example, if there is a patient at the emergency event location 12 being treated, and if a particular equipment is brought to the emergency event location 12, then an inference may be made that the equipment is being used for the treatment of the patient (so long as there are no other patient at the emergency event location 12) and such information may be logged to the patient electronic file. In the same scenario, the resource tracking and response system 104 may track and record the movements of the patient even after the emergency event has been resolved. That is, when a patient, such as an emergency room (ER) patient, is processed by a medical facility, they are typically moved from one location to another (e.g., emergency room, x-ray, MRI, operating room, and so forth) in the medical facility during the intake process. This is to ensure that a patient has not be “lost” as it is not unheard of for the healthcare providers to “lose” a patient (e.g., lose track of where the patient is in the facility) during the intake processing of a patient.

Accordingly, in embodiments where the resource tracking and control platform 10 is used in connection with a medical facility, such as in the above scenario, each patient may be tagged with a location tag to track the movements and locations of each patient and the times associated with these movements and locations. Recording such information may be beneficial in terms of treatment of the patient. That is, by tracking the movements of a patient, a determination can be made as to, for example, which treatments and/or procedures has the patient undergone to ensure that the patient was properly processed and that the patient underwent all the correct treatments/examination in a timely manner. Such data may be accurately recorded automatically by the resource tracking and response system 104 in accordance with various embodiments of the present disclosure.

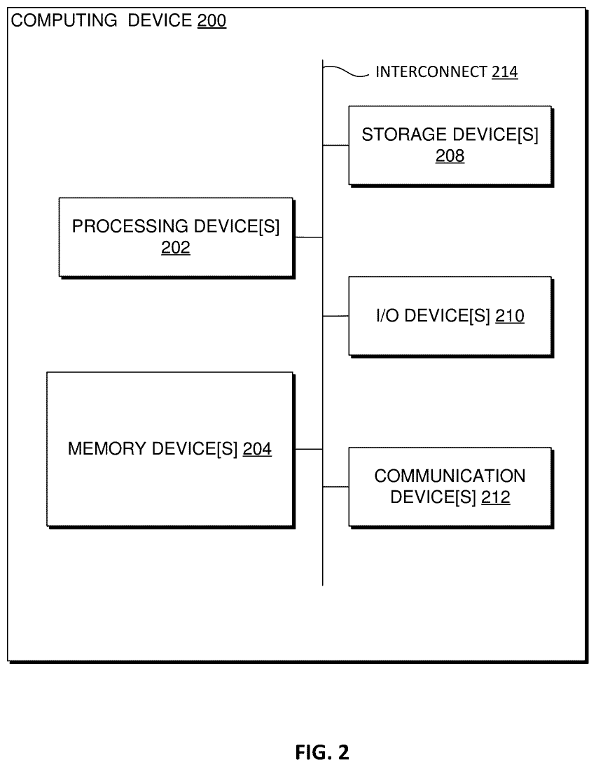

FIG. 2 is a high-level block diagram of an example computing device 200 in accordance with some example embodiments. In various embodiments, the computing device 200 may be used to implement the emergency response coordination (ERC) system and methods described above. In some alternative embodiments, a plurality of computing devices 200 (e.g., cloud implementation) may implement the ERC system and methods described above. Note that for the purposes of the following description references to a computing system may be in reference to one or more computing devices 200 of FIG. 2.

As illustrated, the computing device 200 may include one or more processing devices 202, one or more memory devices 204, one or more storage devices 208, one or more input/output (I/O) devices 210, and one or more communication devices 212, all coupled together via an interconnect 214. The one or more memory devices 204 may store computer-readable instructions, which may also be stored in one or more storage devices 208, for executing, among other things, the various operations of the ERC methods described herein. For example, the processes and logic flow to be described herein can be performed by one or more processing devices 202 executing the computer-readable instructions stored in the memory device [s] 204 and/or the storage device [s] 208.

The interconnect 214 may be or include one or more conductive traces, buses, point-to-point connections, controllers, adapters, and/or other connection devices. The one or more processing devices 202 may include, for example, one or more processors, digital signal processors (DSPs), controllers, field programmable gate array (FPGA), application specific integrated circuit (ASIC), or the like, or any combination thereof. The one or more memory devices 204 may include one or more physical storage devices, which may be in the form of random access memory (RAM), read-only memory (ROM), flash memory, miniature hard disk drive, or other suitable type of storage device, or a combination of such devices. The one or more storage devices 208 may include one or more hard drives, digital versatile disks (DVDs), flash memories, or the like. As noted above, each of the memory devices 204 and/or storage devices 208 may store, individually or collectively, data and instructions that configure the one or more processing devices 202 to execute operations to implement the processes and operations described herein.

The one or more communication devices 212 may include, for example, a network interface card (NIC), an Ethernet adapter, cable modem, Wi-Fi adapter, cellular transceiver, baseband processor, or the like, or a combination thereof. The one or more I/O devices 210 may include, for example, a display (which may be a touch screen display), audio speaker, keyboard, mouse, or other pointing device, microphone, camera, and so forth. Note that in the case of the computing device 200 being a server, or other devices that do not need to directly communicate with a user, the computing device 200 may not include an I/O device 210.

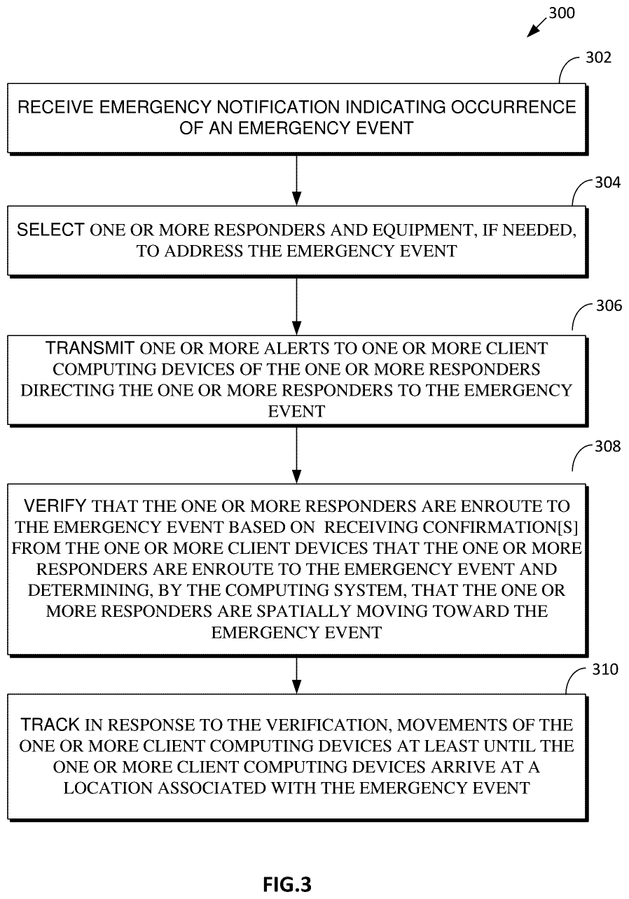

FIG. 3 illustrates an example process 300 for ensuring that a responder or responders and needed equipment reach an emergency event location in a timely manner in accordance with various embodiments. In some embodiments, at least some of the operations illustrated in FIG. 3 may be performed by the emergency response coordination (ERC) system 102 of FIG. 1B, which may be implemented by a computing system, such as one or more computing devices 200 illustrated in FIG. 2. For ease of illustration and to facilitate understanding of process 300, the following discussion of process 300 will reference the systems and features illustrated in FIGS. 1A, 1B, and 2. However, those of ordinary skill in the art will recognize that process 300 may be implemented using systems and features other than those illustrated in FIGS. 1A, 1B, and 2.

The example process 300 may begin when a reception operation 302 for receiving an emergency notification indicating an occurrence of an emergency event is performed. For instance, and as an illustration, a computing system (e.g., the one or more computing devices 200 of FIG. 2 implementing the ERC system 102 of FIG. 1B) electronically receiving an emergency notification indicating an occurrence of an emergency event. In some embodiments, the emergency notification may provide an indicator (e.g., address, coordinates, or a location code) to indicate the location of the emergency event. In some embodiments, the emergency notification may indicate the emergency type (e.g., code blue, code red, and so forth) of the emergency event. Alternatively, the emergency notification may include a textual or audio description of the emergency event (e.g., “patient has no pulse”) provided by, for example, a user (e.g., an emergency caller) such as a healthcare worker or a responder at the emergency event location. Note that although the emergency event to be described below will be described as a medical emergency, in various alternative embodiments, the emergency event may be any one of a fire emergency, a police emergency such as an active shooter or a child abduction, a hazardous spill, and so forth. In some embodiments, the emergency event location may be in an indoor facility, such as a hospital, a school building, an office building, an airport terminal, and so forth.

In some embodiments, the emergency notification is received from a computing device at the emergency event. For example, the computing system (the one or more computing devices 200 of FIG. 2 implementing the ERC system 102 of the resource tracking and control platform of FIG. 1A) receiving the emergency notification from a computing device 26 at the emergency event location 12. In various embodiments, the computing device 26 may be a mobile device (e.g., a smartphone, a tablet computer, and so forth) in possession of a user, such as a client computing device of a healthcare worker or responder, a computerized patient monitoring system or robotic system, and so forth.

In some embodiments, the reception operation 302 for receiving the emergency notification includes determining a type of emergency that has occurred with respect to the emergency notification based, at least in part, on information included in the emergency notification. For example, if the emergency notification received by the computing system includes a textual or audio message from a user (e.g., a certified nursing assistant) at the emergency event location providing an informal description of the emergency (e.g., “patient stopped breathing”) then the ERC system 102 (implemented by the computing system) may determine the emergency type (e.g., code blue) of the emergency event.

In some embodiments, the reception operation 302 for receiving the emergency notification includes determining the location of the emergency event based, at least in part, on information included in the emergency notification. For example, and with reference to FIGS. 1A, 1B, and 2, the computing system (e.g., the one or more computing devices 200 of FIG. 2 implementing the ERC system 102) upon receiving the emergency notification that includes a location code or an identifier for the computing device 26 that transmitted the emergency notification from the emergency event location 12 determines the location of the emergency event based on the location code or the identifier of the computing device 26. Alternatively, the computing system implementing the ERC system 102 may independently determine the location of the computing device 26 using, for example, one of the positioning systems (e.g., UWB or LPS system to track the location of the mobile computing device of the caller who generated the emergency notification) described above to determine the location of the emergency event. In some embodiments, the emergency notification received by the computing system may include coordinates for the emergency event.

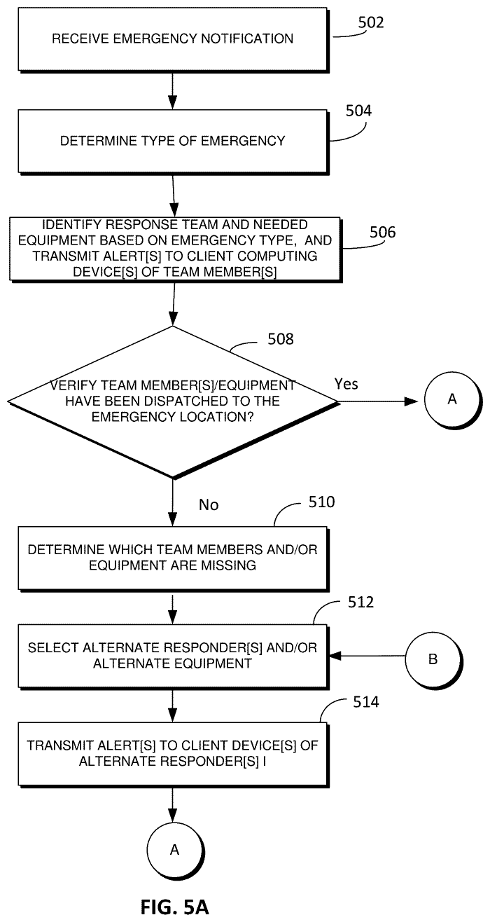

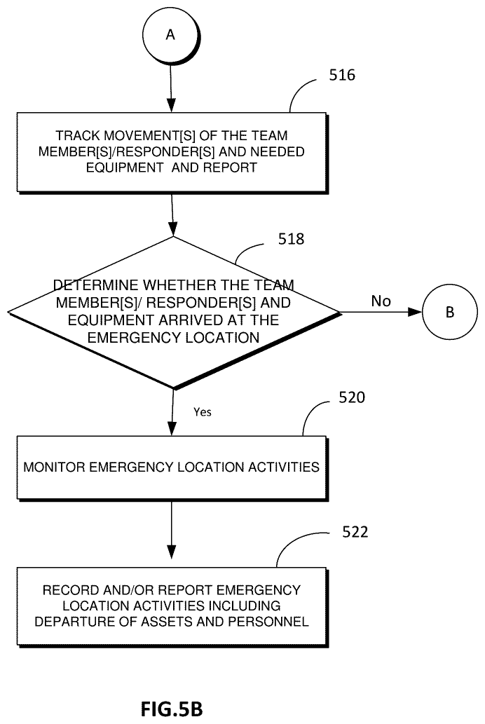

Although not illustrated in FIG. 3, the operations introduced above to determine team members of a response team designated to respond to the emergency type of emergency event including any equipment needed, to contact the determined team members to direct the team members to the emergency event location, and to determine whether any of the team members including any needed equipment are not enroute to the emergency event, may be performed after the reception operation 302. That is, although not illustrated in FIG. 3, such operations are included in process 500 of FIGS. 5A and 5B, which is a particular implementation of process 300 according to some embodiments. In embodiments where such operations are performed, the following operation to select one or more responders to respond to an emergency event may be used to find alternate personnel to replace the missing team members. Note that a team member of a designated response team is merely a responder who is designated to handle the type of emergency (e.g., code blue) associated with the emergency event.

As further illustrated in FIG. 3, process 300 may also include a selection operation 304 for selecting one or more responders including equipment, if the equipment is needed, to address the emergency event. For instance, the computing system (e.g., the one or more computing devices 200 of FIG. 2 implementing the ERC system 102) selecting one or more responders (e.g., responders associated with client computing devise 14a, 14c, and 14f in FIG. 1A) including equipment 26a, if the equipment 26a is needed, to address the emergency event. As will be further described herein, among the factors that may be considered in selecting the one or more responders and the equipment are their locations relative to the emergency event location and their locations relative to each other (e.g., a responder who is near the needed equipment may be selected due to his or her proximity to the needed equipment). Other basis for selecting the one or more responders include their current availability (e.g., whether they checked in and are on duty), their qualifications (e.g., certification or license), listed specialty, experience, and so forth, as described herein.

In cases where there are many potential responders who could be selected to respond to the emergency event, the potential responders may be ranked according to their qualifications and their proximity to the emergency event location, their location relative to the location of the equipment, and/or based on duty rotation and equally distributed work load422. This may be particularly helpful in situations where alternates may need to be quickly selected when the originally selected responders are unavailable.

In various embodiments, the selection operation 304 for selecting the one or more responders including the equipment, if the equipment is needed, is based at least in part on type of emergency of the emergency event. For instance, and with reference to FIGS. 1A, 1B, and 2, the computing system (e.g., one or more computing devices 200 of FIG. 2 implementing the ERC system 102 of the Resource Tracking Control Platform 10) selecting the one or more responders (e.g., responders associated with the client computing devices 14a, 14c, and 14f) including the equipment 16a (e.g., cardio cart), if the equipment 16a is needed, is based at least in part on type of emergency (e.g., code blue) of the emergency event (c., cardiac arrest).

In some embodiments, the selection operation 304 for selecting one or more responders, including the equipment, if the equipment is needed, is based at least in part on the locations of the one or more client computing devices of the one or more selected responders and the equipment relative to the location associated with the emergency event. For instance, and with reference to FIGS. 1A, 1B, and 2, the computing system (e.g., one or more computing devices 200 of FIG. 2 implementing the ERC system 102 of the Resource Tracking Control Platform 10) selecting the one or more responders including the equipment 16a, if the equipment 16a is needed, based at least in part on locations of the one or more client computing devices 14a, 14c, and/or 14f of the one or more selected responders and the location of the equipment 16a relative to the emergency event location 12. For example, and as a further illustration, if there are multiple advanced cardiac life support (ACLS) carts spread throughout a medical facility, the selection of which cart to use may depend on the relative locations of the responders and/or the emergency event location 12 with respect to the relative locations of the ACLS carts.

In some embodiments, the selection operation 304 for selecting the one or more responders includes selecting at least one of the one or more responders based on a location of the client computing device of the at least one of the one or more responders relative to the location of the equipment. For instance, the computing system, implementing the ERC system 102, selecting the one or more responders by selecting a responder based on the location of the client computing device 14a of the responder relative to the location of the equipment 16a. That is, selecting the responder associated with the client computing device 14a because the client computing device 14a is nearest to the equipment 16a.

In various embodiments, the selection operation 304 for selecting the one or more responders is based on the qualifications (e.g., field of expertise, certifications, experience, and so forth) of the one or more responders.

In various embodiments, the one or more responders that are selected in the selection operation 304 are selected after one or more previously selected responders (e.g., team members of a response team, such as a code team, assigned to respond to the emergency type of the emergency event) were unavailable for responding to the emergency event.

In various embodiments, process 300 of FIG. 3 may also include a transmission operation 306 for transmitting one or more alerts to one or more client computing devices of the one or more selected responders, respectively, the one or more alerts directing the one or more selected responders to the emergency event. For instance, the computing system (e.g., the one or more computing devices 200 of FIG. 2 implementing the ERC system 102) transmitting electronically alerts to the client computing devices 14a, 14c, and 14f of the selected responders, respectively, the alerts directing (e.g.,, requesting) the selected responders to the emergency event 12. As will be further described herein, the alerts that may be transmitted may each include certain information such as the coordinates or address of the emergency event location 12, and the type of emergency associated with the emergency event (e.g., emergency information such as code type).

In some embodiments, the transmission of the one or more alerts to one or more client computing devices of the one or more selected responders includes providing to the one or more client computing devices one or more routes, respectively, to an emergency event location of the emergency event from current locations of the one or more client computing devices. For example, the computing system (e.g., the one or more computing devices 200 of FIG. 2 implementing the ERC system 102) transmitting one or more alerts to one or more client computing devices 14a, 14e, and 14f of the one or more selected responders includes providing to the one or more client computing devices 14a, 14c, and 14f one or more routes, respectively, to an emergency event location 12 of the emergency event from current locations of the one or more client computing devices 14a, 14fe, and 14f. That is, since each selected responder may be located in different locations, they may each be provided, through their client computing device 14a, 14c, or 14f, their own routes to the emergency event location 12 from their current location.

In some implementations, a route may be provided to a client computing device 14a, 14c, or 14f of a selected responder by electronically transmitting to the client computing device 14a, 14c, or 14f of the selected responder a complete electronic route. Alternatively, an address, coordinates, or a location identifier may be provided to the client computing device 14a, 14c, or 14f of the selected responder in embodiments where the client computing device 14a, 14c, or 14f is endowed with a navigation system capable of navigating through, for example, a three-dimension structure (e.g., a building). Note that in some embodiments, the route information may be transmitted separately after the initial alert was sent to the client computing device 14f and after the selected responder associated with the client computing device 14f has confirmed that he or she will be enroute to the emergency event.

In various embodiments, the one or more alerts to be transmitted identify an emergency type of the emergency event. For instance, the computing system (e.g., the one or more computing devices 200 of FIG. 2 implementing the ERC system 102) transmitted alerts to the client computing devices 14a, 14e, and 14f of the elected responders that identify an emergency type (e.g., code yellow) of the emergency event. In some embodiments, the one or more alerts to be transmitted identify a location of the emergency event. For example, providing the coordinates or a location identifier of the emergency event location 12 in the alerts to be transmitted.

In some embodiments, the transmission of one or more alerts to one or more client computing devices of the one or more selected responders includes transmitting to a client computing device of one of the one or more selected responders route information to reach the location of the emergency event from a location of the client computing device of the one of the one or more selected responders via a location of the equipment. For example, the computing system (e.g., the one or more computing devices 200 of FIG. 2 implementing the ERC system 102) transmitting one or more alerts to one or more client computing devices 14a, 14c, and 14f of the one or more selected responders includes transmitting to a client computing device 14a of one of the one or more selected responders route information (e.g., full electronic route) to reach the location of the emergency event from a location of the client computing device 14a of the one of the one or more selected responders via a location of the equipment 16a. For instance, the route information transmitted by the computing system (e.g., the one or more computing devices 200 of FIG. 2 implementing the ERC system 102) to the client computing device 14a of one of the selected responders includes a route to reach the emergency event location 12 from a location of the client computing device 14a of one of the selected responders via a location of the equipment 16a. That is, at least one of the selected responders (e.g., the responder associated with the client computing device 14a in FIG. 1A) may be designated to bring the selected equipment 16a to the emergency event location 12 and therefore, detoured to the location of the equipment 16a before being routed to the emergency event location.

In various embodiments, process 300 of FIG. 3 may further include a verification operation 308 for verifying that the one or more selected responders are enroute to the emergency event by verifying receiving a confirmation or confirmations from the one or more client computing devices of the one or more selected responders that the one or more selected responders are enroute to the emergency event and determining whether the one or more client computing devices are spatially moving toward the emergency event. For instance, the computing system (e.g., the one or more computing devices 200 of FIG. 2 implementing the ERC system 102) executing a two-step verification to verify that the selected responders are enroute to the emergency event location 12 by verifying receiving confirmations from the client computing devices 14a, 14c, and 14f of the selected responders that the selected responders are enroute (e.g., begun their trek) to the emergency event location, and determining whether the client computing devices 14a, 14c, and 14f are, in fact, spatially moving toward the emergency event location 12.

In some embodiments, the client computing devices 14* of responders may be loaded with a client application that provides a graphical user interface (GUI) that allows a user (e.g., a selected responder) to confirm or not confirm that the user will be enroute to an emergency event location 12. In various embodiments, the determination that the client computing devices 14a, 14c, and 14f of the selected responders are spatially moving toward the emergency event location 12 may be based on a determination of a respective route for each of the client computing devices 14a, 14c, and 14f (in the possession of their selected responder) to the emergency event location 12 and determining whether each of the client computing devices 14a, 14c, and 14f of the selected responders have deviated from their respective route, or determining whether each of client computing devices 14a, 14c, and 14f has stopped moving along their assigned route.

In some embodiments, the verification operation 308 for determining whether the one or more client computing devices are spatially moving toward the emergency event is by determining whether the one or more client computing devices are spatially moving toward the emergency event within a predefined period of time following reception of the confirmation or confirmations from the one or more client computing devices. For instance, the computing system (e.g., the one or more computing devices 200 of FIG. 2 implementing the ERC system 102) determining whether the client computing devices 14a, 14e, and 14f of the selected responders are spatially moving toward the emergency event location 12 is by determining whether the client computing devices 14a, 14c, and 14f are spatially moving toward the emergency event location 12 within a predefined period of time following reception of the confirmations from the client computing devices 14a, 14c, and 14f. In some embodiments, the predefined period of time is 20 seconds or less.

In the some embodiments, if one of the one or more client computing devices is determined not to be spatially moving toward the emergency event within the predefined period of time following reception of a confirmation from the one of the one or more client computing devices that confirms that a selected responder associated with the one of the one or more client computing devices is enroute to the emergency event then transmit a reminder to the one of the one or more client computing devices requesting the selected responder to continue moving towards the emergency event or transmit an alert to a client computing device of an alternate responder directing the alternate responder to the emergency event. For instance, if the client computing device 14a of a selected responder is determined by the computing system (e.g., the one or more computing devices 200 of FIG. 2 implementing the ERC system 102) not to be spatially moving toward the emergency event location 12 within the predefined period of time (e.g., 20 seconds) following reception of a confirmation from the client computing device 14a that confirms that the selected responder is enroute to the emergency event then the computing system (e.g., the one or more computing devices 200 of FIG. 2 implementing the ERC system 102) transmits a reminder to the client computing device 14a requesting the selected responder to continue moving towards the emergency event location 12 or transmit an alert to a client computing device 14c of an alternate responder directing the alternate responder to the emergency event.

In various embodiments, the determining whether the one or more client computing devices are spatially moving toward the emergency event may be based on positioning data provided by at least one of a local positioning system (LPS), ultra-wide band (UWB) positioning system, radio frequency identification (RFID) system, BLUETOOTH Low Energy (LE) system, or Xtreme Low Energy (XE®) system.

Referring back to FIG. 3, process 300 may also include a tracking operation 310 for tracking, in response to the verification, movements of the one or more client computing devices at least until the one or more client computing devices arrive at a location associated with the emergency event. For instance, the computing system (e.g., the one or more computing devices 200 of FIG. 2 implementing the ERC system 102) tracking, in response to the verification, movements of the client computing devices 14a, 14c, and 14f at least until the client computing devices 14a, 14e, and 14f arrive at the emergency event location 12. If the client computing device 14a, 14c, or 14f of a selected responder deviates from their assigned route or is detected not moving towards the emergency event location 12, then a reminder or query may be sent to the client computing device 14a, 14c, or 14f of the selected responder to confirm that the selected responder is still enroute to the emergency event location 12. If the selected responder does not confirm that he or she is still enroute to the emergency event location 12, or if the client computing device 14a, 14c, or 14f is not detected moving towards the emergency event location 12 for at least a predefined amount of time (e.g., 20 seconds) after confirming that he or she will be enroute to the emergency event location 12 then an alert may be transmitted to the client computing device 14b of an alternate responder directing the alternate responder to the emergency event location 12.

In some embodiments, the tracking operation 310 for tracking the movements of the one or more client computing devices includes transmitting movement information of the one or more client computing devices to a computing device located at the emergency event. For instance, the computing system (e.g., the one or more computing devices 200 of FIG. 2 implementing the ERC system 102) tracking the movements of the client computing devices 14a, 14c, and 14f includes transmitting movement information of the client computing devices 14a, 14c, and 14f to a computing device 26 (e.g., maybe a client computing device of a user such as a responder or a patient monitoring system) located at the emergency event location 12.

In some embodiments, the tracking operation 310 for tracking the movements of the one or more client computing devices includes tracking movements of the equipment at least until the equipment arrives at the location associated with the emergency event and transmitting movement information of the equipment to a computing device located at the emergency event. For instance, the computing system (e.g., the one or more computing devices 200 of FIG. 2 implementing the ERC system 102) tracking the movements of the client computing devices 14a, 14c, and 14f includes tracking movements of the equipment 16a at least until the equipment 16a arrives at the emergency event location 12 and transmitting movement information of the equipment 16a to a computing device 26 located at the emergency event location 12. In some cases, the computing device 26 may have transmitted the emergency notification. In some embodiments, the movement information of the equipment 16a may be transmitted by the computing system to a client computing device 14a, 14c, or 14f of at least one of the one or more selected responders.

In various embodiments, if, during tracking of the movements of the equipment, the equipment is determined not to be moving towards or stopped moving towards the location associated with the emergency event, transmit a reminder or query to a client computing device of one of the one or more selected responders who is designated to bring the equipment to the location associated with the emergency event to prompt the designated selected responder to bring the equipment to the location associated with the emergency event or to prompt the designated selected responder to respond to the query. For instance, if, during tracking of the movement of the equipment 16a, the equipment 16a is determined by the computing system not to be moving towards or stopped moving towards the emergency event location 12, then the computing system transmits a reminder or query to a client computing device 14a of the selected responder who is designated to bring the equipment 16a to the emergency event location 12 to prompt the designated selected responder to bring the equipment 16a to the emergency event location 12 or to prompt the designated selected responder to respond to the query (e.g., querying why the designated selected responder has stopped or whether the designated selected responder will be bringing the equipment 16a to the emergency event location 12).

Similarly, in some embodiments, if, during the tracking of the movements of the one or more client computing devices, one of the one or more client computing devices is determined not to be moving towards the location associated with the emergency event, then transmit a reminder to the one of the one or more client computing devices requesting a selected responder associated with the one of the one or more client computing devices to continue moving towards location of the emergency event or transmit an alert to a client computing device of an alternate responder directing the alternate responder to the emergency event. For instance, if, during the tracking of the movements of the client computing devices 14a, 14c, and 14f of the selected responders, the client computing device 14e is determined not to be moving towards the emergency event location 12, then the computing system transmits a reminder to the client computing device 14c requesting the selected responder associated with the client computing device 14c to continue moving towards the emergency event location 12 or the computing system transmits an alert to a client computing device 14d of an alternate responder directing the alternate responder to the emergency event location 12.

As noted above, in various embodiments, the above-described process 300 may be implemented by a computing system, which may include one or more computing devices 200 (e.g., one or more desktop computers, laptop computers, mobile devices, servers, and/or the like), that include one or more processors (e.g., processing devices [s] 202 of FIG. 2), and a memory (e.g.,. memory device [s] 204 of FIG. 2) that contains instructions that when executed by the one or more processors may cause the computing system to perform the above-described process 300. In some embodiments, the instructions may be stored in one or more non-transitory computer-readable storage media.

In various embodiments, the above-described method may be performed when one or more processors execute instructions stored in one or more non-transitory computer-readable storage media.

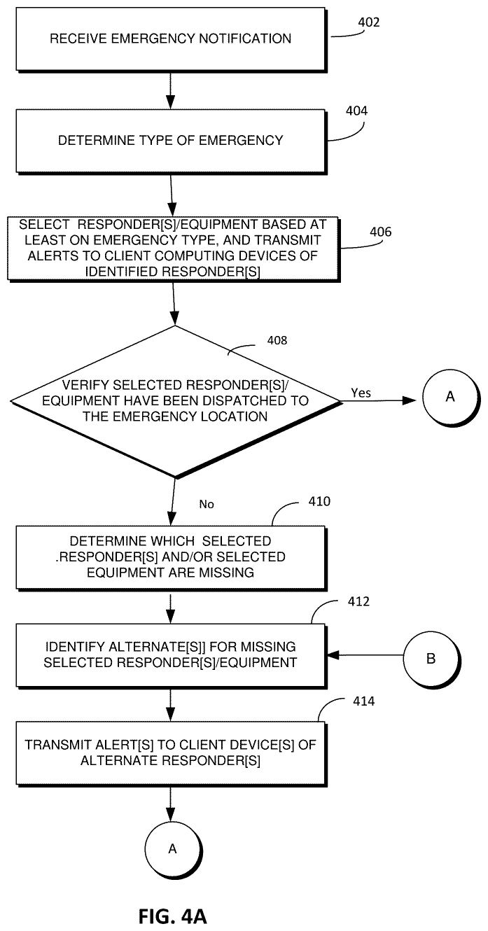

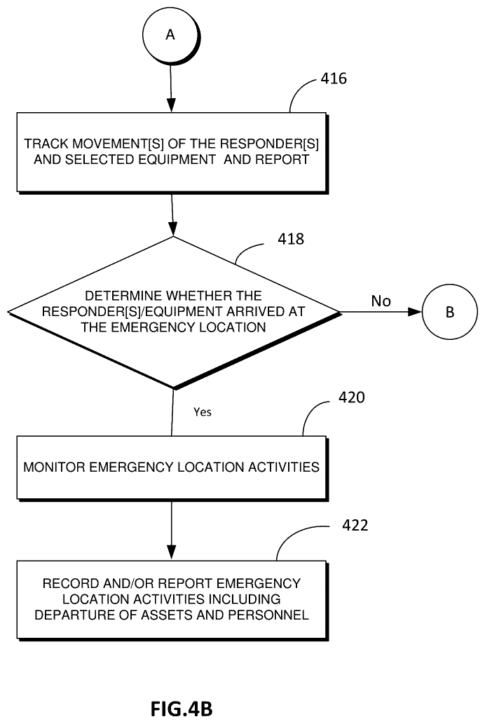

FIGS. 4A and 4B illustrate another example process 400 for ensuring that a responder or responders and needed equipment reach an emergency event location in a timely manner in accordance with various embodiments. More particularly, the example process 400 is a particular implementation of the example process 300. In some embodiments, at least some of the operations illustrated in FIG. 4 may be performed by the emergency response coordination (ERC) system 102 of FIG. 1B, which may be implemented by a computing system, such as one or more computing devices 200 illustrated in FIG. 2.

In some embodiments, process 400 may begin at 402 when an emergency notification is received that indicates the occurrence of an emergency event. In various embodiments, the emergency notification may textually or audibly describe an emergency or indicate the emergency type of the emergency event and may indicate the emergency event location (e.g., coordinates, address, location code, or device identifier of the computing devices that generated the emergency notification).

At 404 a determination may be made to determine the emergency type of the emergency event. In some cases, this may entail simply reading/processing the content of the emergency notification if the emergency notification provides an emergency type (e.g., code red, code blue, code yellow, and so forth). Alternatively, if the emergency notification merely includes a colloquial description of the emergency event (e.g., “fire,” “no pulse,” “infant abduction,” and so forth), then the emergency type of the emergency event may be ascertained based on the words/language included in colloquial description.

In some cases, the determination operation of 404 may include determining the location of the emergency event. For example, if the emergency notification that was received only provides an identifier for the computing device (e.g.,, patient monitoring equipment located at the emergency event location that generated the emergency notification, and if that computing device is assigned to the emergency event location (e.g., a monitoring system in a patient room) then the location of that computing device can be easily ascertained based on its identity. Alternatively, if the computing device used to generate the emergency notification is a mobile client computing device, such as a smartphone, then using, for example, one of the positioning systems previously described, the location of the emergency event may be ascertained (assuming that the computing device is at the emergency event location), or the client computing device may be requested/queried to provide its own location.

At 406, one or more responders and equipment, if the equipment is needed, may be selected to respond to the emergency event based, at least in part, on the type of emergency of the emergency event, and alerts may be sent to the one or more client computing devices of the one or more selected responders. The selection of the one or more responders and the equipment, if the equipment is needed, may also be based on the relative current locations of the one or more responders, the equipment, and the emergency event location. That is, the selection of the one or more responders and the equipment from a plurality of potential responders and equipment may be based on their proximity to the emergency event location and their relative locations to each other (e.g., selecting a responder based at least in part on their proximity to the equipment that is needed at the emergency event). A number of other factors may be considered in selecting the one or more responders including their qualifications, experience, whether they are active (e.g., on duty), and so forth. In various embodiments, during the selection process for selecting one or more responders, potential responders who are qualified (e.g., qualified based on their credential, experience, certification, physical abilities, positions, responsibilities, and so forth) to respond to the emergency event may be ranked (e.g., responder ranking) according to their qualifications and their location relative to the location of the emergency event so that alternate responders may be selected if the original responders are unavailable.

The alerts that may be sent to the one or more client computing devices of the one or more selected responders may include certain information such as emergency type and location of the emergency event. They may also require the recipient to indicate acceptance or acknowledgment that the recipient of the alert (e.g., the selected responder) will be responding to the emergency event.

The transmission of the alerts to the one or more client computing devices may include providing routes to the emergency event location from the current locations of the one or more client computing devices. The routes may be provided in different ways in various alternative embodiments. For example, in some embodiments, the routes may be provided by including them in the original alerts transmitted to the one or more client computing devices. Alternatively, the routes may be separately sent from the original alerts. For example, in some embodiments, the routes may only be sent after the one or more selected responders of the one or more client computing devices have confirmed that they will be responding to the emergency event after receiving the original alert or alerts.

Note that although in some embodiments, the routes to the emergency event may be transmitted to the one or more client computing devices, in other embodiments, only the coordinates or address of the emergency event may be transmitted to the one or more client computing devices. That is, if the one or more client computing devices are endowed with a navigation system/application capable of, for example, navigating through a multi-storied structure, and are loaded with a map of such a structure, then the one or more client completing devices may only need to be provided with the coordinates of the emergency event location or other location identifier to generate a route to the emergency event location.

In some embodiments, at least one of the selected responders may be designated to bring the selected equipment to the emergency event location and may be routed to the selected equipment (e.g., provided the route to the selected equipment) so that the designated responder can bring the selected equipment to the emergency event location.

At 408 verifications may be made to verify that all of the one or more selected responders and the selected equipment are enroute (e.g., have been dispatched), or at least have begun their trek (e.g., on their way) to the emergency event location. The verification that each of the one or more selected responders are responding to the emergency event may be based on two-step authentication that requires that each selected responder confirm that they are responding to the emergency notification/emergency event, and verify that they are physically moving towards the emergency event within a predefined period (e.g., 20 seconds) after they have confirmed that they will be responding to the emergency event. The verification that the selected equipment is enroute may be accomplished in at least two ways, the first way is when the selected responder who has been designated to bring the selected equipment confirms that he or she has secured the selected equipment and will be bringing the selected equipment to the emergency event location. The second way is to detect that the selected equipment (which may be tagged with a location tag) is physically moving toward the emergency event location. In some embodiments, both approaches may be required to verify that the equipment is enroute to the emergency event location. That is, in some embodiments, the verification that the selected equipment is enroute requires a two-step verification (e.g., verification from the selected responder designated to bring the selected equipment to the emergency event location that the selected responder has secured the selected equipment and is bringing the selected equipment, and verification that the selected equipment is physically moving towards the emergency event location).

If all the one or more selected responders and the selected needed equipment have been verified as being enroute (e.g., have at least begun their trek or movements towards the emergency event location), then process 400 moves to 416 where the movements of the one or more selected responders (or more accurately, the movements of the one or more client computing devices of the one or more selected responders) and the selected equipment may be tracked, and the tracked movements may be reported to, for example, the computing device at the emergency event location that may have generated the emergency notification.

At 418 a determination may be made as to whether all of the one or more selected responders and the selected equipment that was needed arrived at the emergency event location. If not, process 400 moves to 412 (see FIG. 4A). On the other hand, if all of the one or more selected responders and the selected equipment did arrive at the emergency event location, then at 420 the activities of the emergency event location may be monitored. In some embodiments, this may entail tracking movements of resources (e.g., responders including, for example, healthcare providers, equipment, medicine, and so forth) that arrive and/or leave from the emergency event location, the use of certain equipment at the emergency event location, patient physiological data, and so forth.

At 422, the activities at the emergency event location that are monitored may be recorded as emergency event activity data and, in some cases, reported. In some embodiments, the emergency event activity data that is recorded may be stored in a database or a datastore and may be inked together and associated with the emergency event. For these embodiments, the linking of the activities data to the emergency event may be based on the location associated with the activities and the time frame in which the activities occurred (e.g., the emergency event can be characterized by its location and the time in which the emergency event occurred).

Referring back to 408 in FIG. 4A, if any of the one or more of the selected responders and/or selected equipment (in cases where the equipment is needed) are determined not to be enroute to the emergency event location, then process 400 moves to 410 where a determination is made as to which of the one or more selected responders and/or selected equipment is or are missing (e.g. cannot be verified as being enroute to the emergency event location).

Upon determining at 410 which of the one or more selected responders and/or selected equipment is or are missing, at 412 one or more alternate responders and/or alternate equipment (if the alternate equipment is needed) may be selected to replace the missing selected responder [s] and/or equipment. In various embodiments, the one or more alternate responders and/or alternate equipment may be selected based on the same basis used for selecting the original responders and equipment. For example, the selection of the alternate responders may be based on their relative locations with respect to the emergency event location and, in some cases, with respect to the location of the alternate equipment. Other factors that may be considered in selecting the alternate responders include, for example, the responders' qualifications, experience, certifications, availability, and so forth, as before. In still other embodiments, the selection of the one or more alternate responders may be based on their responder ranking. That is, and as previously described, during the original selection process for selecting one or more responders to respond to an emergency event, potential responders may be ranked according to their credentials, t heir locations relative to the emergency event location, and/or based on other factors.

In some cases, the originally selected responder [s] designated to bring the originally selected equipment to the emergency event for some reason is unable to secure and bring the originally selected equipment to the emergency event location, then one of the alternate responders, or one of the originally selected responders, may be routed to the location of the originally selected equipment to secure and bring the originally selected equipment to the emergency event location. Alternatively, if the originally selected equipment is truly missing, or is delayed in being delivered to the emergency event location, then alternate equipment may be selected, and an alternate responder or one of the originally selected responders may be routed to the alternate equipment to bring to the emergency event location.

At 414, one or more alerts may be transmitted to one or more client computing devices of one or more alternate responders to direct/request them to the emergency event location. In various embodiments, the transmission of the one or more alerts may include providing routes to the one or more client computing devices of the one or more alternate responders. Process 400 then moves to 416, which was previously discussed above, to track the movements of the selected responders/equipment (e.g., originally selected responders/equipment as well as any alternate responders/equipment-note that alternate responders and alternate equipment are selected responders/equipment).

FIGS. 5A and 5B illustrate yet another example process 500 for ensuring that a responder or responders and needed equipment reach an emergency event location in a timely manner in accordance with various embodiments. More particularly, the example process 500, similar to process 400, is a particular implementation of the example process 300. The primary difference between process 500 and process 400 is that in process 500, initial operations may be performed to identify an appropriate response team designated to respond to the emergency type of the emergency event, send alerts to team members of the identified team, and if any of the team members are unavailable to respond to the emergency event, select alternate responders, where the operation to select alternate responder is similar to or the same as the operation for selecting responders in process 400 of FIG. 4. Further, and as those of ordinary skill in the art will recognize, many of the operations to be described herein with respect to process 500 mirror those of process 400. Accordingly for purposes of succinctness, some details of the operations of process 500 may be omitted.

In some embodiments, at least some of the operations illustrated in FIG. 5 may be performed by the ERC system 102 of FIG. 1B, which may be implemented by a computing system, such as one or more computing devices 200 illustrated in FIG. 2

As illustrated, in various embodiments, process 500 may begin at 502 when an emergency notification is received that indicates the occurrence of an emergency event. In various embodiments, the emergency notification may textually or audibly describe an emergency or indicate the emergency type (e.g., code blue, code yellow, etc.) of the emergency event and may indicate the emergency event location (e.g., coordinates, address, location code, or device identifier of the computing devices that generated the emergency notification). In some embodiments, the emergency notification may include a colloquial description, which may be a textual or audio description, of the emergency event (e.g., “fire,” “no pulse,” “infant abduction,” and so forth) provided by an “emergency caller” at the emergency event location.

At 504 a determination may be made to determine the emergency type of the emergency event. In some cases, this may entail simply processing/reading the content of the emergency notification if the emergency notification provides an emergency type (e.g., code red, code blue, code yellow, and so forth). Alternatively, if the emergency notification merely includes a colloquial description of the emergency event (e.g., “fire,” “no pulse,” “infant abduction,” and so forth), then in some embodiments the emergency type of the emergency event may be ascertained based on specific words/language included in the colloquial description.

[In some cases, the determination operation of 504 may include determining the location of the emergency event. For example, if the emergency notification that was received only provides an identifier for the computing device at the emergency event location that generated the emergency notification, and if that computing device is assigned to the emergency event location (e.g., a monitoring system in a patient room) then the location of that computing device can be easily ascertained based on its identity. Alternatively, if the computing device used to generate the emergency notification is a mobile client computing device, such as a smartphone, then using, for example, one of the positioning systems previously described, the location of the emergency event may be ascertained (assuming that the computing device is at the emergency event location), or the client computing device may be requested/queried to provide its own location. In still other embodiments, the computing device that generated the emergency notification may automatically provide its location, which in cases where the computing device is at the emergency event location, will identify the emergency event location.

At 506 a response team and needed equipment may be identified/determined for addressing/resolving the emergency event based, at least in part, on the emergency type of the emergency event, and based on the identification, one or more alerts may be transmitted to one or more client computing devices of one or more team members of the response team. The needed equipment may be identified/selected based, at least in part, the emergency type of the emergency event and the location of the needed equipment relative to the locations of one or more members of the response team and/or the emergency event location.

In various embodiments, the one or more alerts to be transmitted may include certain information, including, for example, one or more descriptions of the emergency event, the emergency type of the emergency event, the location of the emergency event, and so forth. The one or more alerts may also require/request the recipient to indicate acceptance or acknowledgment that the recipient of the alert (e.g., the selected responder) will be responding to the emergency event. In some embodiments, the transmission of the one or more alerts may include providing to the one or more client computing devices of the one or more team members one or more routes to reach the emergency event location form the current locations of the one or more team embers. The routes may be provided in different ways in various alternative embodiments. For example, in some embodiments, the routes may be provided by including them in the original alerts transmitted to the one or more client computing devices of the one or more team members of the response team. Alternatively, the routes may be separately sent from the original alerts. For example, in some embodiments, the routes may only be sent after the one or more team members of the one or more client computing devices have confirmed that they will be responding to the emergency event.

Note that although in some embodiments, the routes to the emergency event may be transmitted to the one or more client computing devices of the one or more team members of the response team, in other embodiments, only the coordinates or address of the emergency event may be transmitted to the one or more client computing devices of the one or more team members of the response team. That is, if the one or more client computing devices are endowed with a navigation system/application capable of, for example, navigating through a multi-storied structure, and are loaded with a map of such a structure, then the one or more client completing devices may only need to be provided with the coordinates of the emergency event location or other location identifier to generate a route to the emergency event location.

In some embodiments, at least one of the one or more team members of the response team may be designated to bring the needed equipment to the emergency event location and may be routed to the needed equipment (e.g., provided the route to the needed equipment) so that the designated team member can bring the selected equipment to the emergency event location.

At 508 verifications may be made to verify that all of the one or more team members of the response team (e.g., which, in essence, are one or more selected responders based on their membership in the response team) and the needed equipment are enroute (e.g., have been dispatched), or at least have begun their trek (e.g., on their way) to the emergency event location. The verification that each of the one or more team members are responding to the emergency event may be based on two-step authentication that requires that each team member confirm that they are responding to the emergency notification/emergency event and verify that they are physically moving towards the emergency event within a predefined period (e.g., 20 seconds) after they have confirmed that they will be responding to the emergency event. The verification that the needed equipment is enroute may be accomplished in at least two ways, the first way is when the designated team member who has been designated to bring the needed equipment confirms that he or she has secured the needed equipment and will be bringing the needed equipment to the emergency event location. The second way is to detect that the needed equipment (which may be tagged with a location tag) is physically moving toward the emergency event location. In some embodiments, both approaches may be required to verify that the equipment is enroute to the emergency event location. That is, in some embodiments, the verification that the selected equipment is enroute requires a two-step verification (e.g., verification from the team member designated to bring the needed equipment to the emergency event location that the designated team member has secured the needed equipment and is bringing the selected equipment, and verification that the selected equipment is physically moving towards the emergency event location).

If all the one or more team members and the needed equipment have been verified as being enroute (e.g., have at least begun their trek or movements towards the emergency event location), then process 500 moves to 516 where the movements of the one or more team member/selected responders (or more accurately, the movements of the one or more client computing devices of the one or more team members/selected responders) and the needed equipment may be tracked, and the tracked movements may be reported to, for example, the computing device at the emergency event location that may have generated the emergency notification. Note that a team member of a response team designated to respond to an emergency event is merely a particular type of a “selected” responder (selected based at least in part on their membership with the response team). Relatedly, the terms “needed” equipment and “selected” equipment, as used herein, are essentially synonymous unless indicated otherwise.

At 518 a determination may be made as to whether all of the one or more team members/responders and the equipment that was needed arrived at the emergency event location. If not, process 500 moves to 512 (see FIG. 5A). On the other hand, if all of the one or more team members/responders and the needed equipment did arrive at the emergency event location, then at 520 the activities of the emergency event location may be monitored. In some embodiments, this may entail tracking movements of resources (e.g., responders including, for example, healthcare providers, equipment, medicine, and so forth) that arrive and/or leave from the emergency event location, the use of certain equipment at the emergency event location, patient physiological data, and so forth.

At 522, the activities at the emergency event location that are monitored may be recorded as emergency event activity data and, in some cases, reported. In some embodiments, the emergency event activity data that is recorded may be stored in a database or a datastore and may be inked together and associated with the emergency event. For these embodiments, the linking of the activities data to the emergency event may be based on the location associated with the activities, the presence or movements of tracked resources (e.g., patient, responders, equipment, etc.), and the time frame in which the activities occurred (e.g., the emergency event can be characterized by its location and the time in which the emergency event occurred).

Referring back to 508 in FIG. 1A, if any of the one or more of the team members and/or needed equipment (in cases where the equipment is needed) are determined not to be enroute to the emergency event location, then process 500 moves to 510 where a determination is made as to which of the one or more team members and/or needed equipment is or are missing (e.g. cannot be verified as being enroute to the emergency event location).

Upon determining at 510 which of the one or more team members/responders and/or needed equipment is or are missing, at 512 one or more alternate responders and/or alternate equipment (if the alternate equipment is needed) may be selected to replace the missing team member [s]/responder [s] and/or missing equipment. In various embodiments, the one or more alternate responders and/or alternate equipment may be selected based on a number of factors including, for example based on their relative locations with respect to the emergency event location and, in some cases, the alternate equipment may be selected based on the relative location of the emergency event location and/or location of a responder (e.g., a selected or alternative responder). Other factors that may be considered in selecting the alternate responders include, for example, the responders' qualifications, experience, certifications, availability, and so forth, as before.

In some cases, where the original equipment is “missing” because one of the team members/responders designated to bring the originally selected (e.g., needed) equipment to the emergency event location for some reason is unable to secure and bring the originally selected equipment to the emergency event location then one of the alternate responders or one of the team members/responders, may be routed to the location of the needed equipment to secure and bring the originally selected equipment to the emergency event location. Alternatively, if the original equipment is truly missing, or is delayed in being delivered to the emergency event location, then an alternate equipment may be selected, and an alternate responder or one of the team members of the response team may be routed to the alternate equipment to bring to the emergency event location.

At 514, one or more alerts may be transmitted to one or more client computing devices of one or more alternate responders to direct/request them to the emergency event location. In various embodiments, the transmission of the one or more alerts may include providing routes to the one or more client computing devices of the one or more alternate responders. Process 500 then moves to 516, which was previously discussed above, to track the movements of the responders/equipment (e.g., team members of the response team and originally selected equipment as well as any alternate responders/equipment).

As noted above, according to various embodiments, resource tracking and response systems and methods are disclosed herein to track locations and movements of one or more resources, and based at least in part, on the movements and/or locations of the one or more resources, execute one or more actions. For these embodiments, a resource may be a person such as a patient, a healthcare provider such as a physician or nurse, a responder as described above, medical equipment, firefighting equipment, and/or other mobile items. The resource tracking and reasons methods may be implemented by the resource tracking and response system 104 of FIG. 1B.

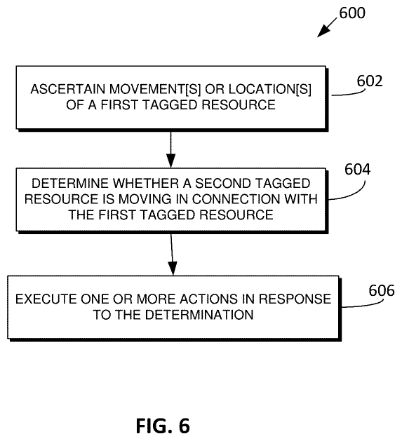

FIG. 6 is an example process 600 for tracking locations or movements of one or more resources, and based at least in part on the locations and/or movements of the one or more resources, execute one or more actions. In various embodiments, at least some of the operations illustrated in FIG. 3 may be performed by the resource tracking and response system 104 of FIG. 1B, which may be implemented by a computing system, such as one or more computing devices 200 illustrated in FIG. 2.

For the embodiments, the example process 600 may begin when an ascertainment operation 602 for ascertaining one or more movements or locations of a first tagged resource is performed. For example, the computing system (the one or more computing devices 200 of FIG. 2 implementing the resource tracking and response system 104 of the resource tracking and control platform of FIG. 1A) ascertaining one or more movements or locations of a first tagged resource, such as a patient, a nurse, a medical cart, and so forth, that has bas been tagged with a location tag to facilitate spatial tracking of the first tagged resource. For the embodiments, a first tagged resource may be in reference to any resource that has been tagged with a location tag, such as a UWB tag, RFID tag, a mobile computing device such as a smartphone, or any other device that can be spatially tracked.

Process 600 may also include a determination operation 604 for determining whether a second tagged resource is moving in connection with the first tagged resource. For instance, the computing system (the one or more computing devices 200 of FIG. 2 implementing the resource tracking and response system 104) determining whether a second tagged resource (e.g., healthcare worker, medical cart, and so forth) is moving in connection with the first tagged asset. As a further example, if the first resource is an infant patient in the maternity ward of a hospital, then the second tagged resource may be a healthcare worker such as a nurse or a physician. Note that the determination operation 604, in some cases, may entail determining whether any second tagged source (e.g., nurse) is moving in connection with the first tagged resource (e.g., an infant).

Process 600 may further include an execution operation 606 for executing one or more actions in response to the determination. For instance, the computing system (the one or more computing devices 200 of FIG. 2 implementing the resource tracking and response system 104) executing one or more actions (e.g., recording the movement activities in connection with an event, transmit notifications to third parties, initiate security procedures, broadcast messages over PA system, and so forth) in response to the determination.

As a further illustration, if the first tagged resource is an infant in the neonatal intensive care unit (NICU), and if the infant is detected leaving the NICU without being accompanied by a tagged healthcare worker (e.g., a nurse or a certified nursing assistant), then law enforcement may be alerted, and security doors may be automatically locked. In another example, if the first tagged resource is an emergency room patient detected leaving the emergency room with a second tagged resource (e.g., a certified nursing assistant) and moving towards the x-ray room, then the x-ray technicians may be alerted that the first tagged resource (e.g., emergency room patient) is on his or her way to the x-ray room.

After reviewing the present disclosure, an individual of ordinary skill in the art will immediately appreciate that some details and features can be added, removed and/or changed without deviating from the spirit of the invention. Reference throughout this specification to “one embodiment,” “an embodiment,” “additional embodiment(s)” or “some embodiments,” means that a particular feature, structure or characteristic described in connection with the embodiment(s) is included in at least one or some embodiment(s), but not necessarily all embodiments, such that the references do not necessarily refer to the same embodiment(s). Furthermore, the particular features, steps, structures, or characteristics may be combined in any suitable manner in one or more embodiments. These and other changes can be made to the embodiments in light of the above-detailed description. In general, in the following claims, the terms used should not be construed to limit the claims to the specific embodiments disclosed in the specification and the claims but should be construed to include all possible embodiments along with the full scope of equivalents to which such claims are entitled.

1. A computer-implemented method, comprising:
receiving, by a computing system, an emergency notification indicating an occurrence of an emergency event;
selecting, by the computing system, one or more responders including equipment, if the equipment is needed, to address the emergency event;
transmitting, by the computing device, one or more alerts to one or more client computing devices of the one or more selected responders, respectively, the one or more alerts directing the one or more selected responders to the emergency event;
verifying, by the computing system, that the one or more selected responders are enroute to the emergency event by verifying receiving a confirmation or confirmations from the one or more client computing devices of the one or more selected responders that the one or more selected responders are enroute to the emergency event and determining, by the computing system, whether the one or more client computing devices are spatially moving toward the emergency event; and
tracking, by the computing system, in response to the verification, movements of the one or more client computing devices at least until the one or more client computing devices arrive at a location associated with the emergency event.

2. The computer-implemented method of claim 1, wherein the emergency notification is received from a computing device at the emergency event.

3. The computer-implemented method of claim 1, wherein receiving the emergency notification includes determining a type of emergency that has occurred with respect to the emergency notification based, at least in part, on information included in the emergency notification.

4. The computer-implemented method of claim 1, wherein receiving the emergency notification includes determining the location of the emergency event based, at least in part, on information included in the emergency notification.

5. The computer-implemented method of claim 1, wherein selecting the one or more responders including the equipment, if the equipment is needed, is based at least in part on type of emergency of the emergency event.

6. The computer-implemented method of claim 5, wherein selecting the one or more responders including the equipment, if the equipment is needed, is based at least in part on locations of the one or more client computing devices of the one or more selected responders and the equipment relative to the location associated with the emergency event.

7. The computer-implemented method of claim 6, wherein selecting the one or more responders includes selecting at least one of the one or more responders based at least in part on a location of the client computing device of the at least one of the one or more responders relative to the location of the equipment.

8. The computer-implemented method of claim 1, wherein the one or more responders are selected after one or more previously selected responders are unavailable for addressing the emergency event.

9. The computer-implemented method of claim 1, wherein the one or more alerts to be transmitted identify a location of the emergency event.

10. The computer-implemented method of claim 1, wherein transmitting one or more alerts to one or more client computing devices of the one or more selected responders includes providing to the one or more client computing devices one or more routes, respectively, to an emergency event location of the emergency event from current locations of the one or more client computing devices.

11. The computer-implemented method of claim 10, wherein transmitting one or more alerts to one or more client computing devices of the one or more selected responders includes transmitting to a client computing device of one of the one or more selected responders route information to reach the location of the emergency event from a location of the client computing device of the one of the one or more selected responders via a location of the equipment.

12. The computer-implemented method of claim 1, wherein determining, by the computing system, whether the one or more client computing devices are spatially moving toward the emergency event is by determining whether the one or more client computing devices are spatially moving toward the emergency event within a predefined period of time following reception of the confirmation or confirmations from the one or more client computing devices.

13. The computer-implemented method of claim 12, wherein the predefined period of time is 20 seconds or less.

14. The computer-implemented method of claim 12, wherein if one of the one or more client computing devices is determined not to be spatially moving toward the emergency event within the predefined period of time following reception of a confirmation from the one of the one or more client computing devices that confirms that a selected responder associated with the one of the one or more client computing devices is enroute to the emergency event then transmit a reminder to the one of the one or more client computing devices requesting the selected responder to continue moving towards the emergency event or transmit an alert to a client computing device of an alternate responder directing the alternate responder to the emergency event.

15. The computer-implemented method of claim 1, wherein tracking the movements of the one or more client computing devices includes transmitting movement information of the one or more client computing devices to a computing device located at the emergency event.

16. The computer-implemented method of claim 1, wherein tracking the movements of the one or more client computing devices includes tracking movements of the equipment at least until the equipment arrives at the location associated with the emergency event and transmitting movement information of the equipment to a computing device located at the emergency event.

17. The computer-implemented method of claim 16, wherein if, during tracking of the movement of the equipment, the equipment is determined not to be moving towards or stopped moving towards the location associated with the emergency event, transmit a reminder or query to a client computing device of one of the one or more selected responders who is designated to bring the equipment to the location associated with the emergency event to prompt the designated selected responder to bring the equipment to the location associated with the emergency event or to prompt the designated selected responder to respond to the query.

18. The computer-implemented method of claim 1, wherein if, during the tracking of the movements of the one or more client computing devices, one of the one or more client computing devices is determined not to be moving towards the location associated with the emergency event, then transmit a reminder to the one of the one or more client computing devices requesting a selected responder associated with the one of the one or more client computing devices to continue moving towards location of the emergency event or transmit an alert to a client computing device of an alternate responder directing the alternate responder to the emergency event.

19. One or more non-transitory computer-readable storage media including instructions that, when executed by one or more processors, cause the one or more processors to perform the steps of:
receive an emergency notification indicating an occurrence of an emergency event;
select one or more responders including equipment, if the equipment is needed, to address the emergency event;
transmit one or more alerts to one or more client computing devices of the one or more selected responders, respectively, the one or more alerts directing the one or more selected responders to the emergency event;
verify that the one or more selected responders are enroute to the emergency event by verifying receiving a confirmation or confirmations from the one or more client computing devices of the one or more selected responders that the one or more selected responders are enroute to the emergency event and determining, by the computing system, whether the one or more client computing devices are spatially moving toward the emergency event; and
track in response to the verification, movements of the one or more client computing devices at least until the one or more client computing devices arrive at a location associated with the emergency event.

20. A computing system, comprising:
one or more processors; and
memory containing instructions that, when executed by the one or more processors, cause the computing system to:
receive an emergency notification indicating an occurrence of an emergency event;
select one or more responders including equipment, if the equipment is needed, to address the emergency event;
transmit one or more alerts to one or more client computing devices of the one or more selected responders, respectively, the one or more alerts directing the one or more selected responders to the emergency event;
verify that the one or more selected responders are enroute to the emergency event by verifying receiving a confirmation or confirmations from the one or more client computing devices of the one or more selected responders that the one or more selected responders are enroute to the emergency event and determining, by the computing system, whether the one or more client computing devices are spatially moving toward the emergency event; and
track in response to the verification, movements of the one or more client computing devices at least until the one or more client computing devices arrive at a location associated with the emergency event.
